(19) United States
(12) Patent Application Publication
(10) Pub. No.: US 2026/0270005 A1
(43) Pub. Date: Sep. 10, 2026

(54) EXPOSURE MANAGEMENT IN THE SPATIAL DOMAIN

(71) Applicant: QUALCOMM Incorporated, San Diego, CA (US)

(72) Inventors: Kianoush HOSSEINI, San Diego, CA (US); Gokul SRIDHARAN, Sunnyvale, CA (US); Peter GAAL, San Diego, CA (US); Timo Ville VINTOLA, San Diego, CA (US); Sumant Jayaraman IYER, San Diego, CA (US)

(21) Appl. No.: 19/070,248

(22) Filed: Mar. 4, 2025

(51) Int. Cl. H04L 5/00; H04W 16/28; H04W 52/36

(52) U.S. Cl. CPC H04L 5/0051; H04W 16/28; H04W 52/367

(57) ABSTRACT

Methods, systems, and devices for wireless communications are described. A user equipment (UE) may receive a first message identifying one or more sounding reference signal (SRS) configurations for the UE, each SRS configuration identifying an SRS resource set for SRS transmissions by the UE as part of an uplink transmission. The UE may transmit a second message identifying at least a first SRS port group and a second SRS port group. The UE may perform the uplink transmission in conjunction with the SRS transmissions according to at least the second message.

### FIELD OF TECHNOLOGY

The following relates to wireless communications, including exposure management in the spatial domain.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first message identifying one or more sounding reference signal (SRS) configurations for the UE, each SRS configuration identifying an SRS resource set for SRS transmissions by the UE as part of an uplink transmission, transmitting a second message identifying at least a first SRS port group and a second SRS port group, and performing the uplink transmission in conjunction with the SRS transmissions according to at least the second message.

A UE for wireless communications is described. The UE may include one or more memories storing processor executable code, and one or more processors coupled with the one or more memories. The one or more processors may individually or collectively be operable to execute the code to cause the UE to receive a first message identifying one or more SRS configurations for the UE, each SRS configuration identifying an SRS resource set for SRS transmissions by the UE as part of an uplink transmission, transmit a second message identifying at least a first SRS port group and a second SRS port group, and perform the uplink transmission in conjunction with the SRS transmissions according to at least the second message.

Another UE for wireless communications is described. The UE may include means for receiving a first message identifying one or more SRS configurations for the UE, each SRS configuration identifying an SRS resource set for SRS transmissions by the UE as part of an uplink transmission, means for transmitting a second message identifying at least a first SRS port group and a second SRS port group, and means for performing the uplink transmission in conjunction with the SRS transmissions according to at least the second message.

A non-transitory computer-readable medium storing code for wireless communications is described. The code may include instructions executable by one or more processors to receive a first message identifying one or more SRS configurations for the UE, each SRS configuration identifying an SRS resource set for SRS transmissions by the UE as part of an uplink transmission, transmit a second message identifying at least a first SRS port group and a second SRS port group, and perform the uplink transmission in conjunction with the SRS transmissions according to at least the second message.

In some examples of the method, user equipment (UEs), and non-transitory computer-readable medium described herein, individual SRS ports of the UE may be selected for inclusion into the first SRS port group or the second SRS port group according to a threshold exposure limit of the UE.

In some examples of the method, user equipment (UEs), and non-transitory computer-readable medium described herein, individual SRS ports may be selected for inclusion into the first SRS port group or the second SRS port group on an SRS port basis or on an SRS resource basis within each SRS resource set.

In some examples of the method, user equipment (UEs), and non-transitory computer-readable medium described herein, individual SRS ports may be selected for inclusion into the first SRS port group or the second SRS port group on a per-band basis or on a per-band within a band combination basis.

In some examples of the method, user equipment (UEs), and non-transitory computer-readable medium described herein, individual SRS ports may be selected for inclusion into the first SRS port group or the second SRS port group on a per-carrier basis or on a per-carrier group basis.

In some examples of the method, user equipment (UEs), and non-transitory computer-readable medium described herein, the second message further identifies a first output power variation for the first SRS port group and a second output power variation for the second SRS port group and the first output power variation may be different from the second output power variation.

In some examples of the method, user equipment (UEs), and non-transitory computer-readable medium described herein, at least two SRS ports in the first SRS port group, in the second SRS port group, or both, may be associated with different SRS resources.

In some examples of the method, user equipment (UEs), and non-transitory computer-readable medium described herein, a transmit power difference associated with a first output power variation and a second output power variation may be based on a maximum differential.

Some examples of the method, user equipment (UEs), and non-transitory computer-readable medium described herein may further include operations, features, means, or instructions for refraining from performing one or more SRS transmissions from at least one SRS port in the first SRS port group, in the second SRS port group, or both, based on a transmit power threshold associated with a first output power variation, a second output power variation, or both.

Some examples of the method, user equipment (UEs), and non-transitory computer-readable medium described herein may further include operations, features, means, or instructions for receiving a signal that identifies a power variation scheme to be applied to a first output power variation, a second output power variation, or both.

Some examples of the method, user equipment (UEs), and non-transitory computer-readable medium described herein may further include operations, features, means, or instructions for transmitting an update message that identifies one or more changes to the first SRS port group, to the second SRS port group, or to both.

In some examples of the method, user equipment (UEs), and non-transitory computer-readable medium described herein, a timing associated with transmission of the update message may be based on a timer associated with SRS port group changes.

In some examples of the method, user equipment (UEs), and non-transitory computer-readable medium described herein, transmission of the update message may be based on occurrence of a triggering event associated with the UE.

A method for wireless communications by a network entity is described. The method may include transmitting, to a UE a first message identifying one or more SRS configurations for the UE, each SRS configuration identifying an SRS resource set for SRS transmissions by the UE as part of an uplink transmission, receiving, from the UE, a second message identifying at least a first SRS port group and a second SRS port group, and receiving the uplink transmission in conjunction with the SRS transmissions according to at least the second message.

A network entity for wireless communications is described. The network entity may include one or more memories storing processor executable code, and one or more processors coupled with the one or more memories. The one or more processors may individually or collectively be operable to execute the code to cause the network entity to transmit, to a UE a first message identifying one or more SRS configurations for the UE, each SRS configuration identifying an SRS resource set for SRS transmissions by the UE as part of an uplink transmission, receive, from the UE, a second message identifying at least a first SRS port group and a second SRS port group, and receive the uplink transmission in conjunction with the SRS transmissions according to at least the second message.

Another network entity for wireless communications is described. The network entity may include means for transmitting, to a UE a first message identifying one or more SRS configurations for the UE, each SRS configuration identifying an SRS resource set for SRS transmissions by the UE as part of an uplink transmission, means for receiving, from the UE, a second message identifying at least a first SRS port group and a second SRS port group, and means for receiving the uplink transmission in conjunction with the SRS transmissions according to at least the second message.

A non-transitory computer-readable medium storing code for wireless communications is described. The code may include instructions executable by one or more processors to transmit, to a UE a first message identifying one or more SRS configurations for the UE, each SRS configuration identifying an SRS resource set for SRS transmissions by the UE as part of an uplink transmission, receive, from the UE, a second message identifying at least a first SRS port group and a second SRS port group, and receive the uplink transmission in conjunction with the SRS transmissions according to at least the second message.

In some examples of the method, network entities, and non-transitory computer-readable medium described herein, individual SRS ports of the UE may be selected for inclusion into the first SRS port group or the second SRS port group according to a threshold exposure limit of the UE.

In some examples of the method, network entities, and non-transitory computer-readable medium described herein, individual SRS ports may be selected for inclusion into the first SRS port group or the second SRS port group on an SRS port basis or on an SRS resource basis within each SRS resource set.

In some examples of the method, network entities, and non-transitory computer-readable medium described herein, individual SRS ports may be selected for inclusion into the first SRS port group or the second SRS port group on a per-band basis or on a per-band within a band combination basis.

In some examples of the method, network entities, and non-transitory computer-readable medium described herein, individual SRS ports may be selected for inclusion into the first SRS port group or the second SRS port group on a per-carrier basis or on a per-carrier group basis.

In some examples of the method, network entities, and non-transitory computer-readable medium described herein, the second message further identifies a first output power variation for the first SRS port group and a second output power variation for the second SRS port group and the first output power variation may be different from the second output power variation.

In some examples of the method, network entities, and non-transitory computer-readable medium described herein, at least two SRS ports in the first SRS port group, in the second SRS port group, or both, may be associated with different SRS resources.

In some examples of the method, network entities, and non-transitory computer-readable medium described herein, a transmit power difference associated with a first output power variation and a second output power variation may be based on a maximum differential.

Some examples of the method, network entities, and non-transitory computer-readable medium described herein may further include operations, features, means, or instructions for refraining from receiving one or more SRS transmissions from at least one SRS port in the first SRS port group, in the second SRS port group, or both, based on a transmit power threshold associated with a first output power variation, a second output power variation, or both.

Some examples of the method, network entities, and non-transitory computer-readable medium described herein may further include operations, features, means, or instructions for transmitting, to the UE, a signal that identifies a power variation scheme to be applied to a first output power variation, a second output power variation, or both.

Some examples of the method, network entities, and non-transitory computer-readable medium described herein may further include operations, features, means, or instructions for receiving, from the UE, an update message that identifies one or more changes to the first SRS port group, to the second SRS port group, or to both.

In some examples of the method, network entities, and non-transitory computer-readable medium described herein, a timing associated with reception of the update message may be based on a timer associated with SRS port group changes.

In some examples of the method, network entities, and non-transitory computer-readable medium described herein, reception of the update message may be based on occurrence of a triggering event associated with the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports exposure management in the spatial domain in accordance with one or more aspects of the present disclosure.

FIG. 2 shows an example of a wireless communications system that supports exposure management in the spatial domain in accordance with one or more aspects of the present disclosure.

FIG. 3 shows an example of a sounding reference signal (SRS) port grouping that supports exposure management in the spatial domain in accordance with one or more aspects of the present disclosure.

FIG. 4 shows an example of a method that supports exposure management in the spatial domain in accordance with one or more aspects of the present disclosure.

FIGS. 5 and 6 show block diagrams of devices that support exposure management in the spatial domain in accordance with one or more aspects of the present disclosure.

FIG. 7 shows a block diagram of a communications manager that supports exposure management in the spatial domain in accordance with one or more aspects of the present disclosure.

FIG. 8 shows a diagram of a system including a device that supports exposure management in the spatial domain in accordance with one or more aspects of the present disclosure.

FIGS. 9 and 10 show block diagrams of devices that support exposure management in the spatial domain in accordance with one or more aspects of the present disclosure.

FIG. 11 shows a block diagram of a communications manager that supports exposure management in the spatial domain in accordance with one or more aspects of the present disclosure.

FIG. 12 shows a diagram of a system including a device that supports exposure management in the spatial domain in accordance with one or more aspects of the present disclosure.

FIGS. 13 through 17 show flowcharts illustrating methods that support exposure management in the spatial domain in accordance with one or more aspects of the present disclosure.

### DETAILED DESCRIPTION

Wireless networks may have various exposure limits that limit the amount of radio frequency (RF) energy that can be transmitted and absorbed by a user. These safety protocols may result in a user equipment (UE) performing various transmit power reductions or adjustments for uplink transmissions to avoid exceeding the exposure limit. Such wireless networks may also utilize sounding reference signal (SRS) transmissions from the UE to manage aspects of channel performance determination and management. The SRS transmissions may be performed according to an SRS configuration that identifies one or more SRS resources. The UE may perform the SRS transmissions using SRS ports (e.g., antennas) of the UE according to the SRS configuration. The SRS configurations may be configured for different usages (e.g., for antenna switching, for carrier switching, for codebook based physical uplink shared channel (PUSCH), for non-codebook based PUSCH, for beam management, and for positioning).

Accordingly, the techniques described herein provide various mechanisms for a UE to group its SRS ports (e.g., antennas) for SRS transmissions in order to comply with the exposure limits associated with the UE. For example, the UE may receive or otherwise obtain a first message that identifies SRS configuration(s) for the UE. Each SRS configuration may identify an SRS resource set for SRS transmissions by the UE as part of an uplink transmission. In some cases, the uplink transmission may be a codebook based uplink transmission type or a non-codebook based uplink transmission type. The UE may transmit or otherwise output a second message that identifies at least a first SRS port group and a second SRS port group. In some cases, individual SRS ports of the UE may be selected for inclusion into the first SRS port group or the second SRS port group according to the threshold exposure limit of the UE. Thus, the UE may perform the uplink transmission in conjunction with the SRS transmissions according to at least the second message.

Aspects of the disclosure are initially described in the context of wireless communications systems. Aspects of the disclosure are further illustrated by and described with reference to apparatus diagrams, system diagrams, and flowcharts that relate to exposure management in the spatial domain.

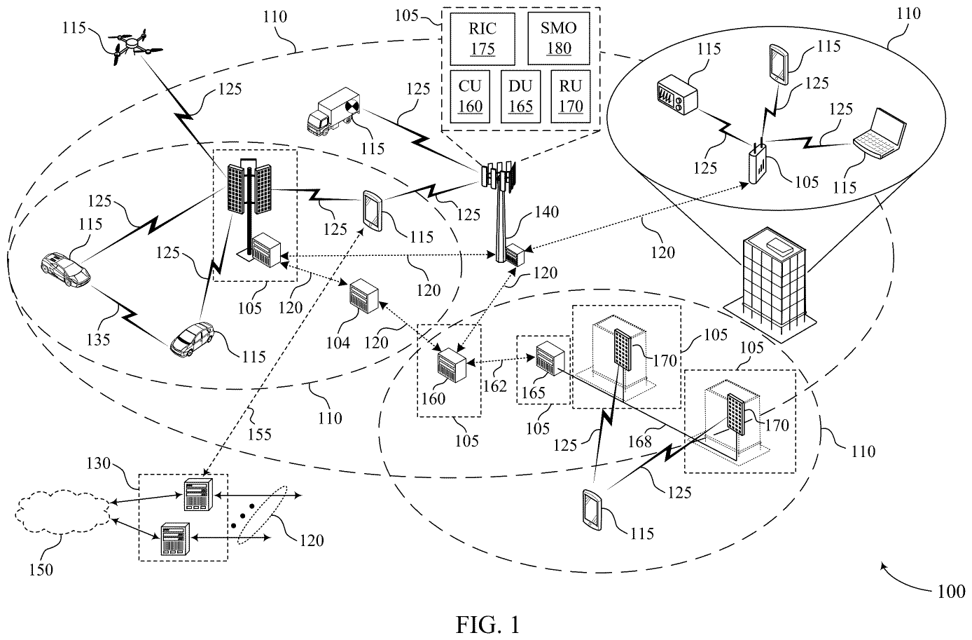

FIG. 1 shows an example of a wireless communications system 100 that supports exposure management in the spatial domain in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support exposure management in the spatial domain as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive a first message identifying one or more SRS configurations for the UE, each SRS configuration identifying an SRS resource set for SRS transmissions by the UE as part of an uplink transmission. The UE 115 may transmit a second message identifying at least a first SRS port group and a second SRS port group. The UE 115 may perform the uplink transmission in conjunction with the SRS transmissions according to at least the second message.

A network entity 105 may transmit, to a UE 115, a first message identifying one or more SRS configurations for the UE 115, each SRS configuration identifying an SRS resource set for SRS transmissions by the UE 115 as part of an uplink transmission. The network entity 105 may receive, from the UE 115, a second message identifying at least a first SRS port group and a second SRS port group. The network entity 105 may receive the uplink transmission in conjunction with the SRS transmissions according to at least the second message.

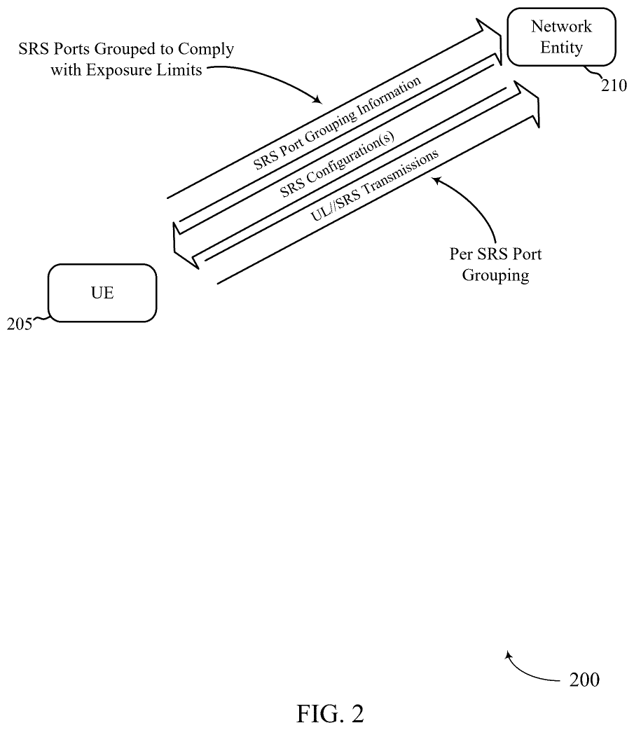

FIG. 2 shows an example of a wireless communications system 200 that supports exposure management in the spatial domain in accordance with one or more aspects of the present disclosure. Aspects of the wireless communications system 200 may implement aspects of or be implemented by aspects of the wireless communications system 100. Aspects of the wireless communications system 200 may include a UE 205 and a network entity 210, which may be examples of the corresponding devices described herein.

Wireless networks may have various exposure limits that limits or otherwise manages aspects of the RF transmissions absorbed by a user. One example of the RF exposure compliance consists of specific absorption rate (SAR) compliance for UEs operating within the wireless network. For wireless networks operating in the sub-6 GHz spectrum the SAR may be used as a metric for RF exposure by the user. The measurement units of the SAR may be in watts/kg that measures the power absorbed by a certain volume of tissue (watts/cm\hat{ }3 may be a reasonable alternative). Another example of the RF exposure compliance consists of a maximum permissible exposure (MPE) compliance that addresses exposure concerns for wireless networks operating in the mmW bands (e.g., RF transmissions in this frequency range can heat human tissue). The metric for the MPE compliance is a power density (PD) having units of Watts/cm\hat{ }2. In some aspects, the SAR and the MPE/PD compliance cannot be treated independently. For example, the sum of the normalized SAR exposure and normalized PD exposure may be capped according to:

$${\sum }_{i = 100 kHz}^{10 GHz} \frac{{SAR}_{i}}{{SAR}_{l im}} + {\sum }_{10 GHz}^{300 GHz} \frac{{PD}_{i}}{{PD}_{l im}} \leq 1 .$$

Wireless networks may also support various uplink dynamic power aggregation techniques. In the downlink scenario, downlink CA operations and functionality has been successfully expanded to some degree. In contrast, uplink CA operations or functionality has not been successfully deployed. In the uplink scenario, the most sought-after resource is UE transmit power. In a large portion of a cell's coverage area, the UE cannot efficiently use more than a fraction of the bandwidth of a single carrier, which indicates that it may be pointless to aggregate more uplink CCs. However, every band that the UE supports represents more transmit power potential. Some wireless networks may introduce uplink dynamic power aggregation in order to tap into this resource (e.g., UE transmit power). The network may allow using the total available short term peak power of the UE. The network may allow a long term (e.g., 30 second) duty cycle control by the UE to maintain SAR compliance. One benefit of this approach is to provide an uplink peak data rate boost and correspondingly increased uplink user perceived throughput rate.

As one example, the averaged power at time t, Pave(t), may be obtained by averaging the instantaneous transmit power, Pinst(t′) within a window (e.g., t−W−D<t′≤t−D), where W is the size of the window and D is the gap from the end of the window and the time t (D can be 0). The UE may set the instantaneous transmit power at time t, Pinst(t), so that Pave (t)≤average limit Pave, max. The UE may set the instantaneous transmit power Pinst(t) so that it is scaled down from the requested power at time t, Preq(t). In some cases, the hardware limit of the UE (e.g., the transmit power limit) can be up to 26 dBm or 28 dBm. If the P_{ave_lim}=23 dBm, the SAR requirement may be met without any additional care or adjustments. If the P_{ave_lim}>23 dBm, additional smart transmit power or uplink duty cycle restrictions may be used.

However, the UE's antennas (e.g., which may be mapped to SRS ports and used for various uplink transmissions) may be located at different sides and corners of the UE. Depending on which antennas are used for certain uplink transmissions, it may happen that their contribution to SAR/MPE are not cumulative. As an example, transmissions from two adjacent antennas could violate SAR/MPE faster than transmission from antennas that are placed at different sides of a device. Antenna placement for managing exposure regulation is an important topic and consideration.

As the contribution of the uplink transmissions to the SAR/MPE (e.g., the threshold exposure limits) from one set of antennas could be different from another set of antennas, the techniques described herein include module grouping or antenna grouping where the SAR/MPE limits are applied per-group. In some cases, the grouping techniques discussed herein may be extended to a transmitted precoding matrix indicator (TPMI) where TPMI groups are identified based on the antennas they use. As one example, a 2Tx UE (e.g., a UE with two transmit chains) with two antenna groups (e.g., each group having a single antenna) may use a [1 0] TPMI that belongs to the first group and [0 1] TPMI that belongs to the second group. In this TPMI example, a TPMI of [1 1] may belong to both groups.

Accordingly, the described techniques provide for a grouping mechanism that works for different types of PUSCH transmissions (e.g., for both codebook (CB) based PUSCH and for non-CB based PUSCH). The described techniques support such grouping signaling as well as the considerations to be used when the grouping can change and when the uplink is scheduled or configured with antennas or modules spanning multiple such groups.

Aspects of the described techniques may be based on SRS transmissions from the UE. The SRS transmissions may be configured for the UE for different usages (e.g., antenna switching (for downlink CSI acquisition), carrier switching (sounding CCs without uplink), CB-PUSCH, non-CB PUSCH, beam management and for positioning). For each usage, a UE can be configured with one or multiple SRS resource sets, where each resource set can contain one or multiple SRS resources. For non-CB based PUSCH a UE may transmit SRS with the usage set to NCB-PUSCH with a precoder selected by the UE. The precoder may be derived by the UE based on downlink/uplink channel reciprocity (e.g., based on the defined association between each SRS resource and a non-zero power-channel state information-reference signal (NZP-CSI-RS) resource). An SRS resource indicator (SRI) in the uplink field can then indicate to the UE which ports (associated with SRS ports) to use for the PUSCH transmission. For CB based PUSCH (e.g., CB-PUSCH) a UE may transmit SRS with usage set to CB-PUSCH. The network may determine the best TPMI for the UE and then request the UE to transmit with that TPMI in the uplink. The antenna ports used for the uplink may be associated with SRS, and via the SRI, UE may be indicated with which ports to use.

An example for SRS (e.g., an SRS configuration) with the usage set to antenna switching for a UE with capability of 2T4R (e.g., two transmit chains/antennas and four receive chains/antennas) may include two antennas/SRS ports being assigned to a first SRS resource during a first SRS transmission period and the other two antennas/SRS ports being assigned to a second SRS resource during a second SRS transmission period. Another example for SRS with the usage set to antenna switching for a UE with a capability of 1T4R may include the antenna/SRS port being assigned to different SRS resources for SRS transmissions during different SRS transmission periods.

Accordingly, in some aspects the network entity 210 may transmit or otherwise output (and the UE 205 may receive or otherwise obtain) a first message that carries or otherwise conveys information that identifies one or more SRS configurations for the UE 205. Broadly, each SRS configuration may include or otherwise identify one or more SRS resource sets for the SRS transmissions by the UE 205 as part of an uplink transmission. In some cases, the uplink transmission may have an associated uplink transmission type. In some cases, the uplink transmission type may include a CB based PUSCH (e.g., a CB based uplink transmission type) or a non-CB based PUSCH (e.g., a non-CB based uplink transmission type). That is, in some cases the SRS configurations provided to the UE 205 may have the usage set to one or both of the CB-PUSCH or the NCB-PUSCH. In some cases, the first message may be sent via RRC signaling, via medium access control-control element (MAC-CE) signaling, or via downlink control information (DCI) signaling from the network entity 210 to the UE 205.

Given that both CB-based PUSCH and NCB-based PUSCH transmissions are associated with SRS transmissions (e.g., SRS transmissions as part of the uplink transmission), the described techniques include antenna/module grouping based on the SRS ports. That is, for each SRS usage (e.g., CB/NCB-PUSCH), the UE 205 may group its SRS ports and report this grouping to the network. For example, the UE 205 may transmit or otherwise output (and the network entity 210 may receive or otherwise obtain) a second message that carries or otherwise conveys information that identifies at least a first SRS port group and a second SRS port group. In some cases, the first SRS port group may be associated with a first uplink transmission type while the second SRS port group may be associated with a second uplink transmission type, or vice versa. As discussed, in some scenarios the first uplink transmission type may include the CB-PUSCH while the second uplink transmission type may include the NCB-PUSCH, or vice versa. In some cases, the first SRS port group and the second SRS port group may both be associated with a first uplink transmission type or the second uplink transmission type. That is, in some use cases the different SRS port groups may be associated with different uplink transmission types (e.g., usage-specific grouping) while in other cases the different SRS port groups may be associated with the same uplink transmission type (SRS groups for the same usage).

In some aspects, the UE 205 may group its antennas (e.g., SRS ports) into group as part of the compliance with the threshold exposure limits associated with the UE 205 (e.g., SRA/MPE compliance limits). That is, individual SRS ports of the UE 205 may be selected for inclusion into the first SRS port group or the second SRS port group according to the threshold exposure limit of the UE 205. The UE 205 may perform (and the network entity 210 may receive) the uplink transmission in conjunction with the SRS transmissions according to at least the second message (e.g., according to the SRS port grouping performed by the UE 205).

In some aspects, this grouping indirectly signals to the network which antennas/modules are grouped together for the purpose of exposure management. The SRS port grouping could be with the granularity of SRS ports or could be with the granularity of SRS resource within each SRS resource set. For example, the individual SRS ports may be selected for inclusion into the first SRS port group or the second SRS port group on an SRS port basis or on an SRS resource set basis within each SRS resource set.

The UE 205 may provide its grouping as a capability (e.g., in a UE capability message) or as a preference (e.g., in a UE assistance information (UAI) message) to the network. That is, in some cases the second message may be provided to the network entity 210 via UE capability signaling, via UAI signaling, or as part of uplink control information (UCI) signaling from the UE 205. In this aspect, the UE 205 may provide to the network which ports it would prefer to be used for uplink transmissions.

In some cases, the UE 205 may group the SRS ports and the corresponding reporting to the network on a per-band (e.g., per frequency band) basis or on a per-band in each band combination. That is, the individual SRS ports of the UE 205 may be selected for inclusion into the first SRS port group or the second SRS port group on the per-band basis or on the per-band within a band combination basis.

In some cases, the individual SRS ports may be selected for inclusion into the first SRS port group or the second SRS port group on a per-carrier basis or on a per-carrier group basis. That is, for intra-band scenarios (both intra-band contiguous and non-contiguous), the UEs may use the same set of antennas across the carriers. However, there are cases that for intra-band non-contiguous, different chains and set(s) of antennas may be used. In such cases, the SRS port grouping and reporting could either be per-carrier (e.g., per-carrier per-band in a band combination) or per-group of carriers (e.g., those contiguous carriers within a non-contiguous intra-band CA) in a band of a band combination.

With regards to such per-UE signaling, there are different ways for the UE 205 to inform the network entity 210 of how the UE changing its maximum output power to meet the SAR/MPE regulations. The side information (e.g., additional information) provided by a UE 205 may provide a forecast on the maximum output power (e.g., the UE's maximum transmit power) to the network. One approach includes the UE reporting its predetermined maximum power reduction (P-MPR) to the network. Another approach includes the UE reporting its P-MPR along with an indication of the duration of time when the P-MPR is applicable (e.g., sustainability window). Another approach includes the UE reporting its energy headroom (EHR) (e.g., how much energy is remaining before violating the exposure limit regulations). Yet another approach includes the UE reporting its EHR along with an indication of the associated sustainability window.

Accordingly, in some aspects the second message transmitted by the UE 205 may include information that identifies a first output power variation for the first SRS port group and a second output power variation for the second SRS port group. The first output power variation may be different from the second output power variation, in some cases. Thus, when the antenna/module/TPMI/SRS grouping and reporting for the purpose of SAR/MPE management is enabled, the additional information that the UE 205 transmits in the second message may give the network a forecast about the maximum output power variations. In some cases, this output power variation information may be reported per SRS group independently by the UE 205. As one example, the UE 205 may report how much P-MPR it has applied to the first group of SRSs (e.g., the first SRS group) in the first band (e.g., the first output power variation). This reported value may be different from the P-MPR that the UE 205 reports for the second group of SRSs (e.g., the second SRS port group) in the first band or any other band (e.g., the second output power variation). If the SRS port grouping happens at the TPMI level, then this information (e.g., output power variation) may be sent for each TPMI group.

Thus, aspects of the described techniques may include decoupling the SRS port power. When moving away from per-UE power backoff/boosting (e.g., via P-MPR) to per-SRS group power management, the receiver complexity may be complex in some scenarios. One example includes the situation where two SRS ports are within two different SRS groups but in the same SRS resource set (e.g., their transmissions are concurrent). Another example includes the situation where the PUSCH is scheduled with rank of greater than one where each port is associated with an SRS in different groups. The issue in such cases is that the higher received power of the stronger layers/ports (those with larger transmit power) may completely wipe out the remaining, weaker, ports/layers. Accordingly, aspects of the described techniques may include various restrictions or configurations being applied when the UE 205 is allowed to apply different power backoffs/boosting to different SRS port groups.

One example may include at least two of the SRS ports in the first SRS port group, in the second SRS port group, or in both SRS port groups being associated with different SRS resources. That is, in this approach the SRS ports from the different SRS port groups may not be in the same SRS resource set. As one example for SRS port sounding, these SRS port transmissions may be TDM transmissions. This may also indicate that the PUSCH cannot be sent using SRS ports from different SRS port groups.

Another example may include a transmit power difference associated with a first output power variation and a second output power variation may be based on a maximum differential. That is, the transmit power difference between the SRS ports in different SRS port groups may be upper bounded by a value X. This value of X may be configured by the network for the UE 205. For example, a UE may not need to apply P-MPR to SRS port(s) in the first SRS port group but is to apply a P-MPR of 6 dB to SRS port(s) in the second SRS port group. In this case, the network may configure X as 3 dB. In such a case, although the P-MPR is not needed for first SRS port group to meet the threshold exposure limits, the UE 205 may apply the P-MPR of 3 dB to this SRS port group.

In some cases, the exact P-MPR for such groups of SRS ports may be based on the exact difference in the power (e.g., 6 dB−3 dB=3 dB in the above example) or there may be some flexibility for a UE to let the UE apply a P-MPR of at least 3 dB in this example. Although it may not be preferable by the UE implementation, the network may instead enforce the UE 205 to apply less P-MPR to the weaker group and so the example above may be applied in the reverse manner (e.g., if the network is aware of the sustainability duration and SAR/MPE measurement window, this option may be supported because the network could then reduce the duty cycle of the usage of the weaker ports). The scaling to the TMPI matrix for CB-PUSCH may then also follow this adjusted power difference across ports. However, it is to be understood that not all entries of the TMPI vector or matrix may be scaled by the same scalar (e.g., different scaling or adjustments per TMPI vector or matrix or per subgroup of TMPI vectors or matrices).

Another example may include the UE 205 refraining from performing (e.g., not performing) SRS transmission(s) from at least one SRS port in the first SRS port group, in the second SRS port group, or in both groups, based on a transmit power threshold associated with a first output power variation, a second output power variation, or both output power variations. That is, the UE 205 may be given a flexibility to not sound some of the SRS ports. These SRS ports could be those that require more P-MPR (e.g., the weakest ports when received by the network entity 210). The UE 205 may be given full flexibility to blank the transmission of such SRS ports when there is P-MPR difference or may be allowed to do so when the power difference is above a threshold (e.g., similar to the value of X discussed above). To align the UE's decision with the network entity 210, the UE 205 may report that it chose not to sound particular SRS ports. Then, the network entity 210 would know the reason was to handle exposures (e.g., to avoid exceeding the threshold exposure limit) and not due to other considerations (e.g., such as hand blocking, poor channel conditions, o) This approach may be seen as non-transparent SRS port adaptation.

Another example may include the UE 205 applying no consideration where the UE 205 may sound all SRS ports regardless of the transmit power difference. This approach may be supported in networks with advanced receiver architecture.

Given that the appropriate behavior may be dependent on the receiver architecture and capabilities of the network entity 210, which option to follow may be indicated to the UE 205 by the network entity 210 (e.g., via a cell-specific system information block (SIB), via a UE-specific RRC, MAC-CE, or DCI, or via other signaling means). Accordingly, in some aspects the network entity 210 may transmit or otherwise output (and the UE 205 may receive or otherwise obtain) a signal that identifies a power variation scheme to be applied to a first output power variation, to a second output power variation, or to both output power variations.

In some cases, the indicated SRS grouping (e.g., as indicated in the second message) may need to be updated due to various reasons. Such reasons include, but are not limited to, the UE 205 entering a dual-connectivity mode or a DS mode of operation; new cells are configured or activated, released, or deactivated; the UE 205 performs antenna switching to gain diversity (e.g., for a given port, a different physical antenna is used); the UE 205 shares or switches antennas across different technologies (e.g., Wi-Fi and cellular); and the like. Accordingly, the described techniques may support the antenna, module, TMPI, SRS grouping being updated by the UE 205. The updated information may be provided to the network entity 210 via RRC signaling, MAC-CE signaling, layer one (L1) signaling, or other signaling means). For example, the UE 205 may transmit or otherwise output (and the network entity 210 may receive or otherwise obtain) an update message that identifies one or more changes to the first SRS port group, to the second SRS port group, or to both SRS port groups. Although this approach may not be preferred based on UE implementation; to ease the operations on the network side to avoid frequent modifications to the grouping the network may impose restriction(s) on how often the SRS grouping may be updated by the UE 205.

One example of such a restriction may be based on the periodicity of the updates made to the antenna, module, TPMI, or SRS port grouping (collectively referred to as an SRS port group) may be restricted by the network. This may be achieved by defining a restricted time/prohibit timer. That is, a timing associated with transmission of the update message may be based on a timer associated with SRS port group changes. For example, every time the UE 205 reports the grouping updates, a timer whose value may be set by the network may start running (e.g., counting down). The UE 205 may not update the SRS port grouping as long as the timer is running. Once the timer has expired, the UE 205 can send modifications if needed (e.g., transmit another update message).

Another example of such a restriction may be based on the restriction of reporting the regrouping may be applied regardless of the cause of the regrouping or may be enforced based on the event that triggered the regrouping. That is, transmission of the update message by the UE 205 may be based on an occurrence of a trigger event associated with the UE 205. For example, if the regrouping is caused by operations commanded by the network (serving cell) (e.g., adding a secondary cell group (SCG), entering a DC mode or configuration/activation of a CC, or other scenarios), the restrictions may not apply. Any one of such operations could trigger an update reporting from the UE 205 without restrictions. In some cases, the triggering event(s) that may trigger the update message may be configured for the UE 205 by the network entity 210. Also, the SRS port grouping information may be sent during an initial access procedure (e.g., before entering an RRC connected state), or only after the access procedure, or during both. The restrictions may be applied to the UE's operations transparent to the network (e.g., a transparent dual-stack, or concurrent Wi-Fi plus cellular operation, or other scenarios).

In some aspects, whenever a UE changes its antenna/port mapping and operations, the network operations relying on averaging the uplink may be impacted. The regrouping indication may be an indication to the network which uplink transmissions can be valid for averaging over time (e.g., those that are before and after the update, may not be averaged together). Additionally, or alternatively, the UE could explicitly send an indication (like a flushing indication) so that the network would not take an average over uplink transmissions that take place before and after the indication.

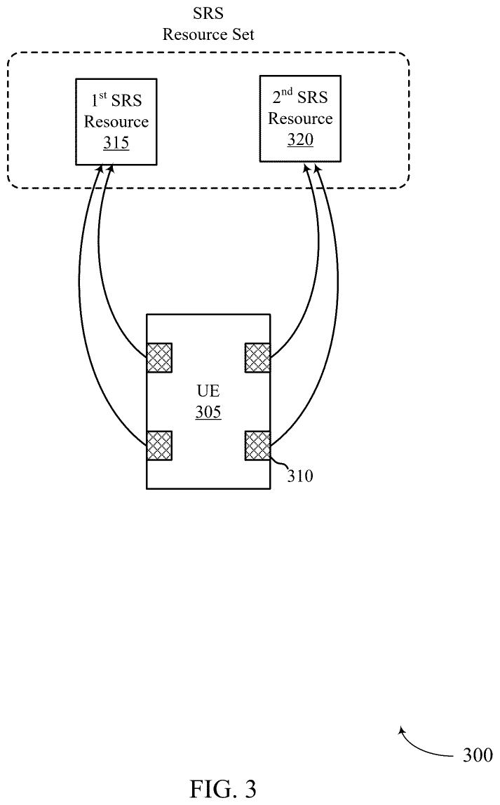

FIG. 3 shows an example of an SRS port grouping 300 that supports exposure management in the spatial domain in accordance with one or more aspects of the present disclosure. Aspects of the SRS port grouping 300 may implement aspects of or by implemented by aspects of the wireless communications system 100 or the wireless communications system 200. Aspects of the SRS port grouping 300 may be implemented at or implemented by a UE (e.g., such as a UE 305) or a network entity, which may be examples of the corresponding devices described herein.

As discussed above, a network entity may transmit or otherwise output (and the UE 305 may receive or otherwise obtain) a first message that carries or otherwise conveys information that identifies one or more SRS configurations for the UE 305. Broadly, each SRS configuration may include or otherwise identify one or more SRS resource sets for the SRS transmissions by the UE 305 as part of an uplink transmission. In some cases, the uplink transmission may have an associated uplink transmission type. In some cases, the uplink transmission type may include a CB based uplink transmission type or a non-CB based uplink transmission type. That is, in some cases the SRS configurations provided to the UE 305 may have the usage set to one or both of the CB-PUSCH or the NCB-PUSCH. In some cases, the first message may be sent via RRC signaling, via MAC-CE signaling, or via DCI signaling from the network entity to the UE 305.

Given that both CB-based PUSCH and NCB-based PUSCH transmissions are associated with SRS transmissions (e.g., SRS transmissions as part of the uplink transmission), the described techniques include antenna/module grouping based on the SRS port(s) 310 of the UE 305. That is, for each SRS usage (e.g., CB/NCB-PUSCH), the UE 305 may group its SRS port(s) 310 and report this grouping to the network. For example, the UE 305 may transmit or otherwise output (and the network entity may receive or otherwise obtain) a second message that carries or otherwise conveys information that identifies at least a first SRS port group and a second SRS port group. In some cases, the first SRS port group may be associated with a first uplink transmission type while the second SRS port group may be associated with a second uplink transmission type, or vice versa.

In some aspects, the UE 305 may group its antennas (e.g., SRS port(s) 310) into group as part of the compliance with the threshold exposure limits associated with the UE 305 (e.g., SRA/MPE compliance limits). That is, individual SRS port(s) 310 of the UE 305 may be selected for inclusion into the first SRS port group or the second SRS port group according to the threshold exposure limit of the UE 305. The UE 305 may perform (and the network entity may receive) the uplink transmission in conjunction with the SRS transmissions according to at least the second message (e.g., according to the SRS port grouping performed by the UE 305).

SRS port grouping 300 illustrates an example for a UE with a 2T4R capability. In some examples, the antenna, module, TPMI, or SRS port grouping may be performed by grouping each SRS port(s) 310 separately (e.g., a first SRS port in the first SRS resource 315 and a second port in the second SRS resource 320 are in one group. In the example shown in FIG. 3, the antenna, module, TPMI, or SRS port grouping may be performed by grouping the SRS port(s) 310 within each SRS resource (e.g., the two SRS ports in the first SRS resource 315 are grouped into the first SRS port group and the two SRS ports in the second SRS resource 320 are grouped into the second SRS port group).

In either example, the UE 305 may select individual SRS port(s) 310 for inclusion into the first SRS port group or into the second SRS port group based on the threshold exposure limits of the UE 305. That is, as shown the different antennas, modules, TPMI, or SRS ports are located on different parts of the UE 305 (e.g., two SRS port(s) 310 on one side and the other two SRS port(s) 310 on the other side of the UE 305). The UE 305 may group SRS port(s) 310 into SRS port groups based on the location of such SRS port(s) 310 considering the threshold exposure limits of the UE 305.

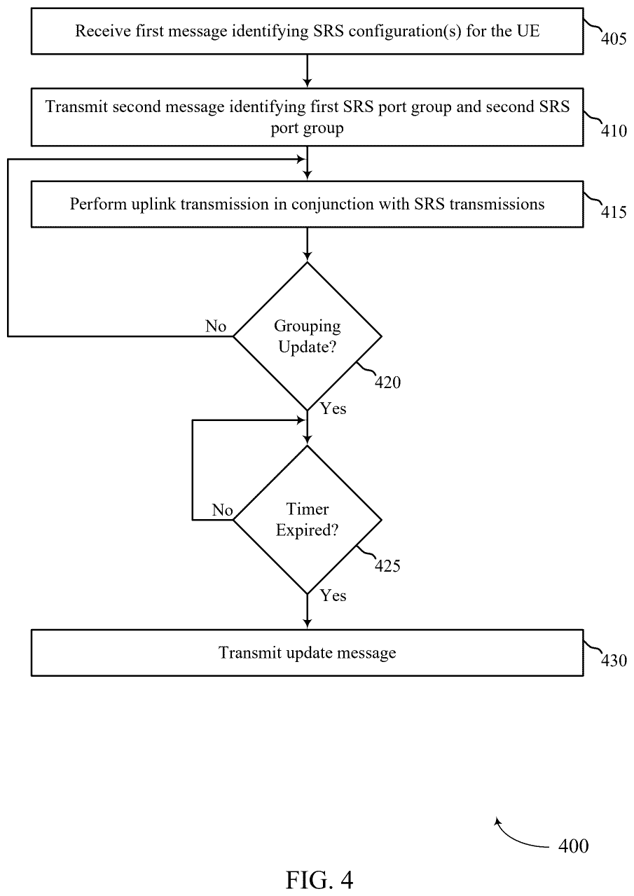

FIG. 4 shows an example of a method 400 that supports exposure management in the spatial domain in accordance with one or more aspects of the present disclosure. Aspects of the method 400 may be implemented at or implemented by aspects of the wireless communications system 100 or the wireless communications system 200 or by aspects of the SRS port grouping 300. Aspects of the method 400 may be implemented at or implemented by a UE or a network entity, which may be examples of the corresponding devices described herein.

At 405, the UE may receive a first message that identifies SRS configuration(s) for the UE. The UE may receive the first message from the network entity (e.g., via RRC signaling, via MAC-CE signaling, via DCI signaling, or via other signaling means). Each SRS configuration that is configured for the UE may identify an SRS resource set for SRS transmissions by the UE as part of an uplink transmission. The uplink transmission may include a CB-PUSCH or a non-CB-PUSCH, in some examples. That is, the usage parameter or field in the SRS resource configuration(s) may be set to either CB-PUSCH or to NCB-PUSCH.

At 410, the UE may transmit a second message that identifies a first SRS port group and a second SRS port group. In some cases, the first SRS port group may be associated with a first uplink transmission type while the second SRS port group may be associated with a second uplink transmission type, or vice versa. In some cases, both the first SRS port group and the second SRS port group are associated with a same uplink transmission type (e.g., either of the first uplink transmission type or the second uplink transmission type). In some cases, the first uplink transmission type and the second uplink transmission type may be the same or may be different. The individual SRS ports of the UE may be selected for inclusion into the first SRS port group or into the second SRS port group based on a threshold exposure limit of the UE. The individual SRS ports of the UE may be selected for inclusion into the first SRS port group or into the second SRS port group on an SRS port basis or on an SRS resource basis within each SRS resource set.

At 415, the UE may perform the uplink transmission in conjunction with the SRS transmissions according to at least the second message (e.g., using the SRS port grouping information indicated in the second message).

At 420, the UE may identify or otherwise determine whether any changes are necessary for the first SRS port group, for the second SRS port group, or to both SRS port groups. The changes may be necessary based on various conditions or events detected by or otherwise associated with the UE (e.g., move to a different cell coverage, transition to a different operational mode, or other scenarios). In some cases, the triggering event(s) that trigger transmission of an update message to implement the changes may be configured for the UE by the network. If no changes are necessary, the UE may return to 415 and continue to perform the uplink transmission in conjunction with the SRS transmissions according to at least the second message.

If changes are necessary, at 425 the UE may identify or otherwise determine whether a timer associated with making changes to the SRS port grouping has expired. The timer may be based on a previous update message updating the SRS port grouping or based on the initial configuration of the SRS port grouping (e.g., the second message). The timer may be configured for the UE by the network entity to avoid frequent changes to the SRS report grouping. If the timer has not expired, the UE may continue to wait for the timer to expire before transmitting an update message to the network entity identifying changes to the first SRS port group, to the second SRS port group, or to both SRS port groups.

If the timer has expired, at 430 the UE may transmit an update message to the network entity that identifies changes to the first SRS port group, to the second SRS port group, or to both SRS port groups.

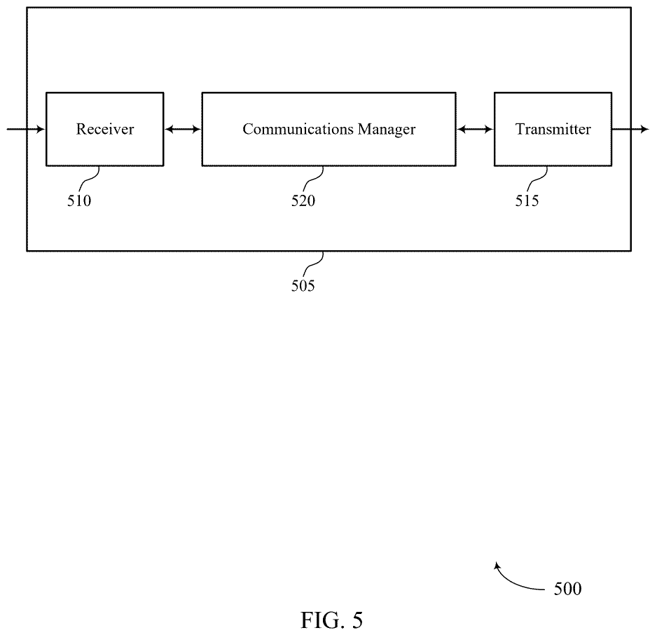

FIG. 5 shows a block diagram 500 of a device 505 that supports exposure management in the spatial domain in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to exposure management in the spatial domain). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to exposure management in the spatial domain). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of exposure management in the spatial domain as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a first message identifying one or more SRS configurations for the UE, each SRS configuration identifying an SRS resource set for SRS transmissions by the UE as part of an uplink transmission. The communications manager 520 is capable of, configured to, or operable to support a means for transmitting a second message identifying at least a first SRS port group and a second SRS port group. The communications manager 520 is capable of, configured to, or operable to support a means for performing the uplink transmission in conjunction with the SRS transmissions according to at least the second message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for SRS port grouping by a UE where different antennas (e.g., SRS ports) are grouped for SRS transmissions in consideration to the threshold exposure limits of the UE.

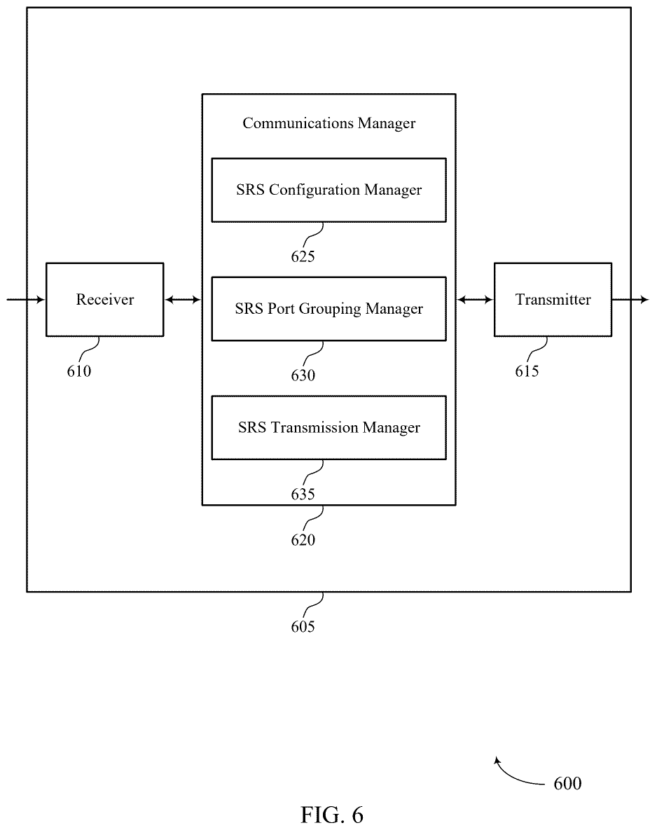

FIG. 6 shows a block diagram 600 of a device 605 that supports exposure management in the spatial domain in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to exposure management in the spatial domain). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to exposure management in the spatial domain). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of exposure management in the spatial domain as described herein. For example, the communications manager 620 may include an SRS configuration manager 625, an SRS port grouping manager 630, an SRS transmission manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SRS configuration manager 625 is capable of, configured to, or operable to support a means for receiving a first message identifying one or more SRS configurations for the UE, each SRS configuration identifying an SRS resource set for SRS transmissions by the UE as part of an uplink transmission. The SRS port grouping manager 630 is capable of, configured to, or operable to support a means for transmitting a second message identifying at least a first SRS port group and a second SRS port group. The SRS transmission manager 635 is capable of, configured to, or operable to support a means for performing the uplink transmission in conjunction with the SRS transmissions according to at least the second message.

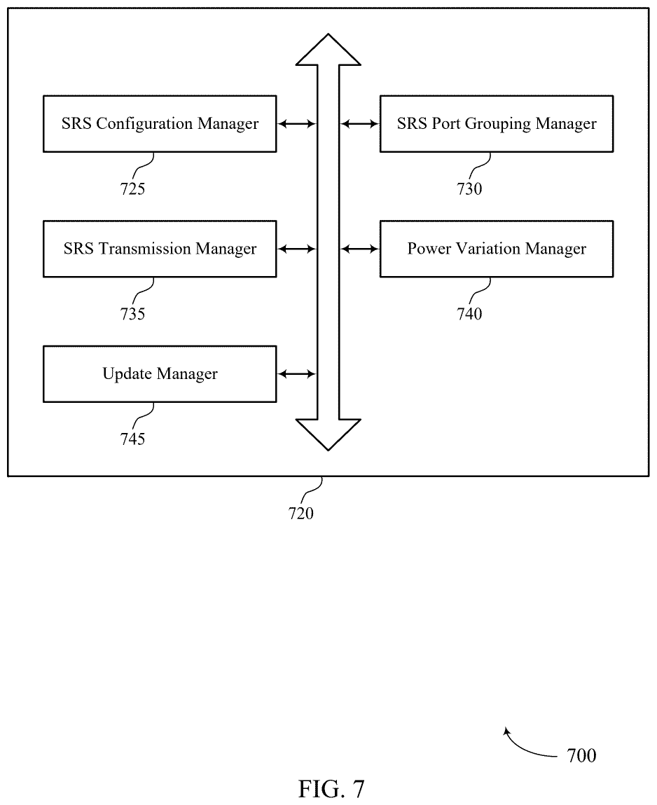

FIG. 7 shows a block diagram 700 of a communications manager 720 that supports exposure management in the spatial domain in accordance with one or more aspects of the present disclosure. The communications manager 720 may be an example of aspects of a communications manager 520, a communications manager 620, or both, as described herein. The communications manager 720, or various components thereof, may be an example of means for performing various aspects of exposure management in the spatial domain as described herein. For example, the communications manager 720 may include an SRS configuration manager 725, an SRS port grouping manager 730, an SRS transmission manager 735, a power variation manager 740, an update manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SRS configuration manager 725 is capable of, configured to, or operable to support a means for receiving a first message identifying one or more SRS configurations for the UE, each SRS configuration identifying an SRS resource set for SRS transmissions by the UE as part of an uplink transmission. The SRS port grouping manager 730 is capable of, configured to, or operable to support a means for transmitting a second message identifying at least a first SRS port group and a second SRS port group. The SRS transmission manager 735 is capable of, configured to, or operable to support a means for performing the uplink transmission in conjunction with the SRS transmissions according to at least the second message.

In some examples, individual SRS ports of the UE are selected for inclusion into the first SRS port group or the second SRS port group according to a threshold exposure limit of the UE. In some examples, individual SRS ports are selected for inclusion into the first SRS port group or the second SRS port group on an SRS port basis or on an SRS resource basis within each SRS resource set.

In some examples, individual SRS ports are selected for inclusion into the first SRS port group or the second SRS port group on a per-band basis or on a per-band within a band combination basis. In some examples, individual SRS ports are selected for inclusion into the first SRS port group or the second SRS port group on a per-carrier basis or on a per-carrier group basis. In some examples, the second message further identifies a first output power variation for the first SRS port group and a second output power variation for the second SRS port group. In some examples, the first output power variation is different from the second output power variation. In some examples, at least two SRS ports in the first SRS port group, in the second SRS port group, or both, are associated with different SRS resources. In some examples, a transmit power difference associated with a first output power variation and a second output power variation is based on a maximum differential.

In some examples, the SRS transmission manager 735 is capable of, configured to, or operable to support a means for refraining from performing one or more SRS transmissions from at least one SRS port in the first SRS port group, in the second SRS port group, or both, based on a transmit power threshold associated with a first output power variation, a second output power variation, or both.

In some examples, the power variation manager 740 is capable of, configured to, or operable to support a means for receiving a signal that identifies a power variation scheme to be applied to a first output power variation, a second output power variation, or both.

In some examples, the update manager 745 is capable of, configured to, or operable to support a means for transmitting an update message that identifies one or more changes to the first SRS port group, to the second SRS port group, or to both. In some examples, a timing associated with transmission of the update message is based on a timer associated with SRS port group changes. In some examples, transmission of the update message is based on occurrence of a triggering event associated with the UE.

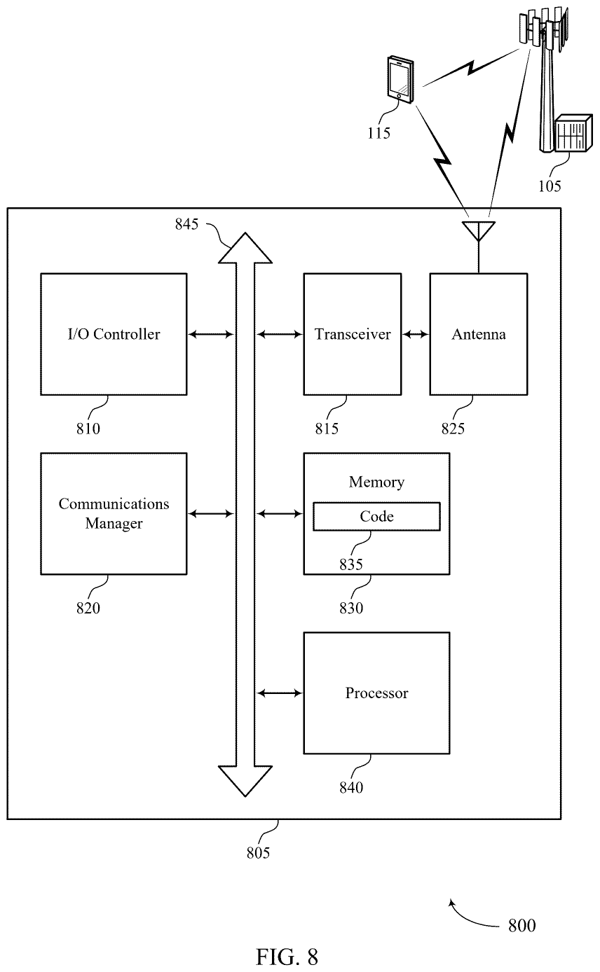

FIG. 8 shows a diagram of a system 800 including a device 805 that supports exposure management in the spatial domain in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting exposure management in the spatial domain). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a first message identifying one or more SRS configurations for the UE, each SRS configuration identifying an SRS resource set for SRS transmissions by the UE as part of an uplink transmission. The communications manager 820 is capable of, configured to, or operable to support a means for transmitting a second message identifying at least a first SRS port group and a second SRS port group. The communications manager 820 is capable of, configured to, or operable to support a means for performing the uplink transmission in conjunction with the SRS transmissions according to at least the second message.

By including or configuring the communications manager 820 in accordance with examples as described herein, the device 805 may support techniques for SRS port grouping by a UE where different antennas (e.g., SRS ports) are grouped for SRS transmissions in consideration to the threshold exposure limits of the UE.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of exposure management in the spatial domain as described herein, or the at least one processor 840 and the at least one memory 830 may be otherwise configured to, individually or collectively, perform or support such operations.

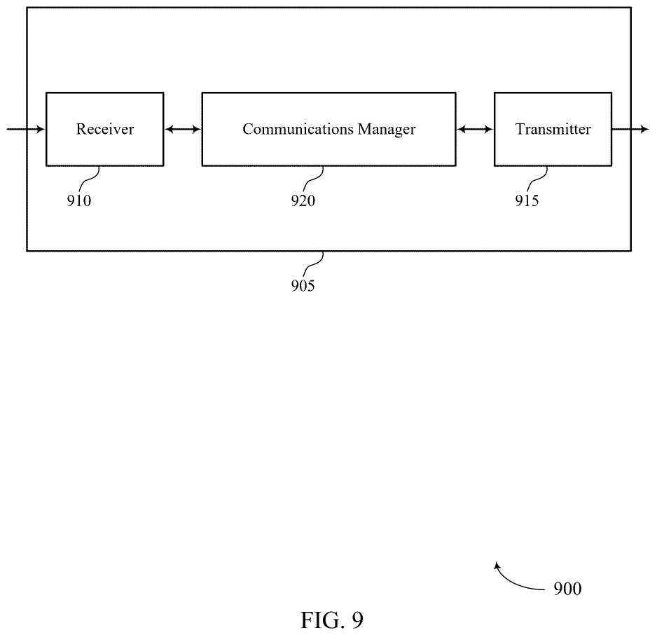

FIG. 9 shows a block diagram 900 of a device 905 that supports exposure management in the spatial domain in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of exposure management in the spatial domain as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE a first message identifying one or more SRS configurations for the UE, each SRS configuration identifying an SRS resource set for SRS transmissions by the UE as part of an uplink transmission. The communications manager 920 is capable of, configured to, or operable to support a means for receiving, from the UE, a second message identifying at least a first SRS port group and a second SRS port group. The communications manager 920 is capable of, configured to, or operable to support a means for receiving the uplink transmission in conjunction with the SRS transmissions according to at least the second message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for SRS port grouping by a UE where different antennas (e.g., SRS ports) are grouped for SRS transmissions in consideration to the threshold exposure limits of the UE.

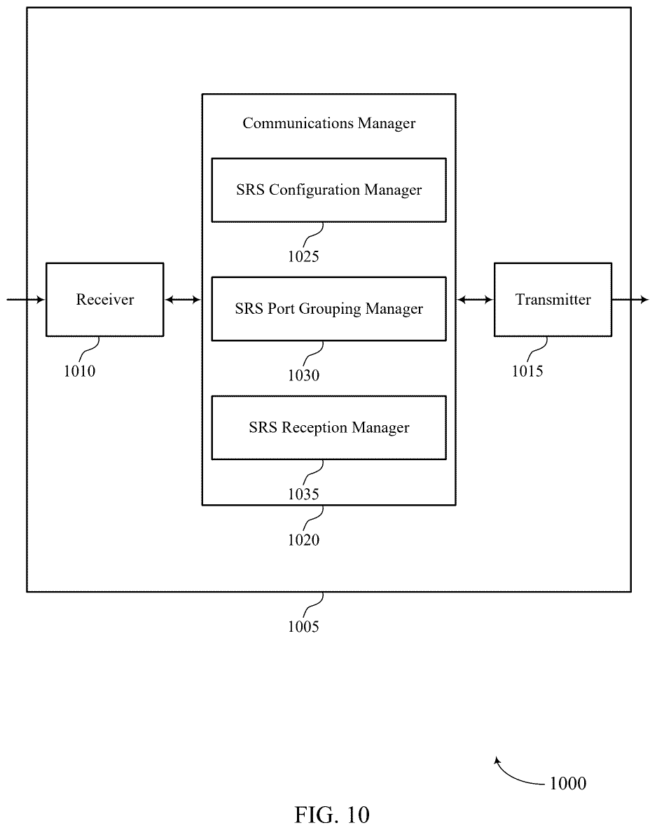

FIG. 10 shows a block diagram 1000 of a device 1005 that supports exposure management in the spatial domain in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of exposure management in the spatial domain as described herein. For example, the communications manager 1020 may include an SRS configuration manager 1025, an SRS port grouping manager 1030, an SRS reception manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The SRS configuration manager 1025 is capable of, configured to, or operable to support a means for transmitting, to a UE a first message identifying one or more SRS configurations for the UE, each SRS configuration identifying an SRS resource set for SRS transmissions by the UE as part of an uplink transmission. The SRS port grouping manager 1030 is capable of, configured to, or operable to support a means for receiving, from the UE, a second message identifying at least a first SRS port group and a second SRS port group. The SRS reception manager 1035 is capable of, configured to, or operable to support a means for receiving the uplink transmission in conjunction with the SRS transmissions according to at least the second message.

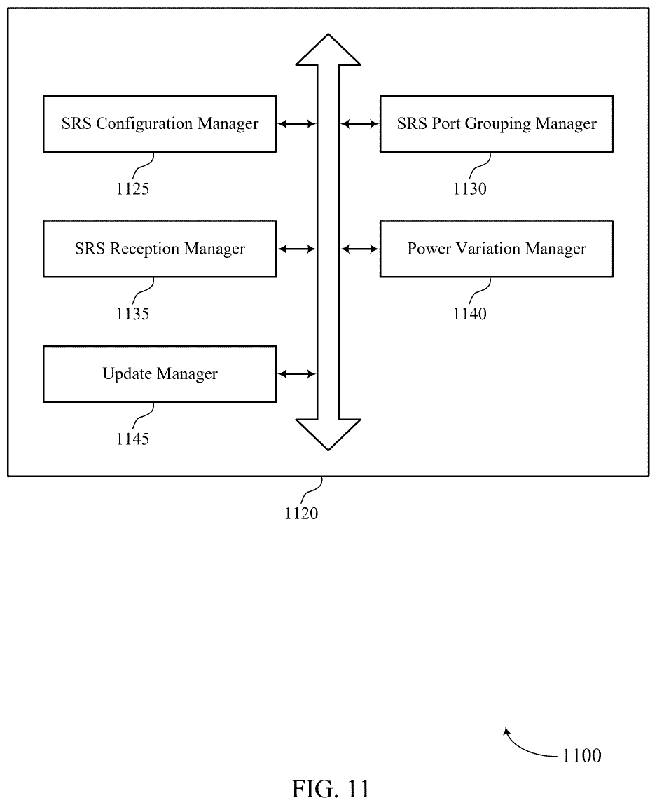

FIG. 11 shows a block diagram 1100 of a communications manager 1120 that supports exposure management in the spatial domain in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of exposure management in the spatial domain as described herein. For example, the communications manager 1120 may include an SRS configuration manager 1125, an SRS port grouping manager 1130, an SRS reception manager 1135, a power variation manager 1140, an update manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The SRS configuration manager 1125 is capable of, configured to, or operable to support a means for transmitting, to a UE a first message identifying one or more SRS configurations for the UE, each SRS configuration identifying an SRS resource set for SRS transmissions by the UE as part of an uplink transmission. The SRS port grouping manager 1130 is capable of, configured to, or operable to support a means for receiving, from the UE, a second message identifying at least a first SRS port group and a second SRS port group. The SRS reception manager 1135 is capable of, configured to, or operable to support a means for receiving the uplink transmission in conjunction with the SRS transmissions according to at least the second message.

In some examples, individual SRS ports of the UE are selected for inclusion into the first SRS port group or the second SRS port group according to a threshold exposure limit of the UE. In some examples, individual SRS ports are selected for inclusion into the first SRS port group or the second SRS port group on an SRS port basis or on an SRS resource basis within each SRS resource set. In some examples, individual SRS ports are selected for inclusion into the first SRS port group or the second SRS port group on a per-band basis or on a per-band within a band combination basis. In some examples, individual SRS ports are selected for inclusion into the first SRS port group or the second SRS port group on a per-carrier basis or on a per-carrier group basis.

In some examples, the second message further identifies a first output power variation for the first SRS port group and a second output power variation for the second SRS port group. In some examples, the first output power variation is different from the second output power variation. In some examples, at least two SRS ports in the first SRS port group, in the second SRS port group, or both, are associated with different SRS resources. In some examples, a transmit power difference associated with a first output power variation and a second output power variation is based on a maximum differential.

In some examples, the SRS reception manager 1135 is capable of, configured to, or operable to support a means for refraining from receiving one or more SRS transmissions from at least one SRS port in the first SRS port group, in the second SRS port group, or both, based on a transmit power threshold associated with a first output power variation, a second output power variation, or both.

In some examples, the power variation manager 1140 is capable of, configured to, or operable to support a means for transmitting, to the UE, a signal that identifies a power variation scheme to be applied to a first output power variation, a second output power variation, or both.

In some examples, the update manager 1145 is capable of, configured to, or operable to support a means for receiving, from the UE, an update message that identifies one or more changes to the first SRS port group, to the second SRS port group, or to both. In some examples, a timing associated with reception of the update message is based on a timer associated with SRS port group changes. In some examples, reception of the update message is based on occurrence of a triggering event associated with the UE.

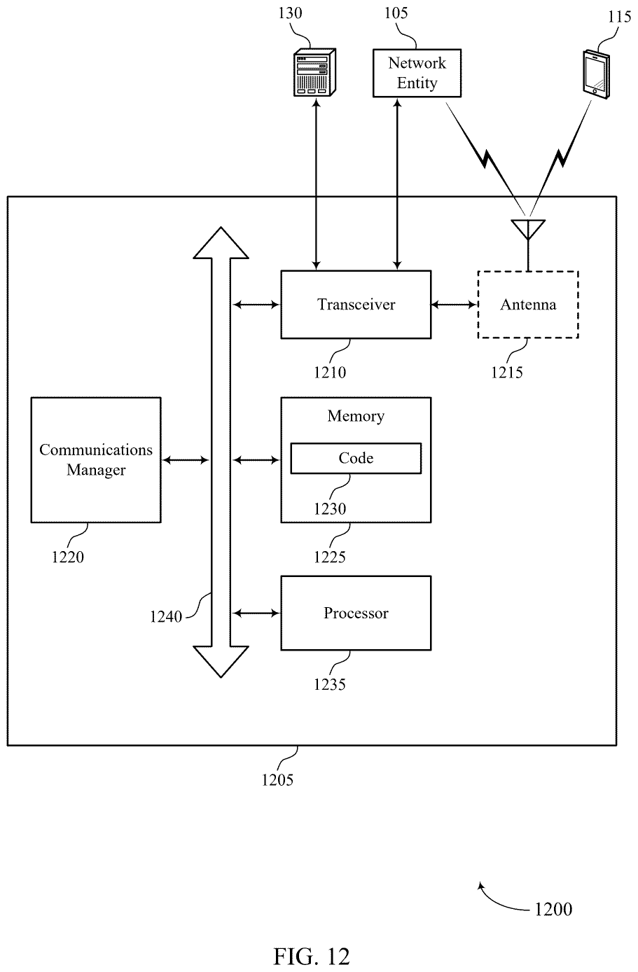

FIG. 12 shows a diagram of a system 1200 including a device 1205 that supports exposure management in the spatial domain in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting exposure management in the spatial domain). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE a first message identifying one or more SRS configurations for the UE, each SRS configuration identifying an SRS resource set for SRS transmissions by the UE as part of an uplink transmission. The communications manager 1220 is capable of, configured to, or operable to support a means for receiving, from the UE, a second message identifying at least a first SRS port group and a second SRS port group. The communications manager 1220 is capable of, configured to, or operable to support a means for receiving the uplink transmission in conjunction with the SRS transmissions according to at least the second message.

By including or configuring the communications manager 1220 in accordance with examples as described herein, the device 1205 may support techniques for SRS port grouping by a UE where different antennas (e.g., SRS ports) are grouped for SRS transmissions in consideration to the threshold exposure limits of the UE.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of exposure management in the spatial domain as described herein, or the at least one processor 1235 and the at least one memory 1225 may be otherwise configured to, individually or collectively, perform or support such operations.

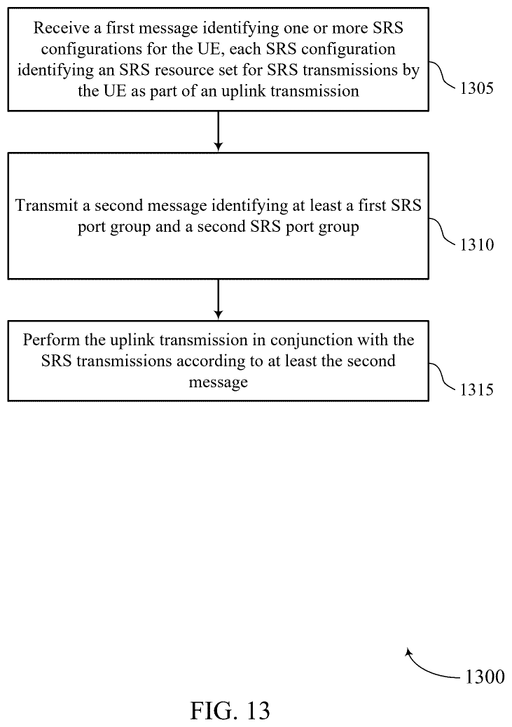

FIG. 13 shows a flowchart illustrating a method 1300 that supports exposure management in the spatial domain in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first message identifying one or more SRS configurations for the UE, each SRS configuration identifying an SRS resource set for SRS transmissions by the UE as part of an uplink transmission. The operations of 1305 may be performed in accordance with examples as disclosed herein. In some examples, aspects of the operations of 1305 may be performed by an SRS configuration manager 725 as described with reference to FIG. 7.

At 1310, the method may include transmitting a second message identifying at least a first SRS port group and a second SRS port group. The operations of 1310 may be performed in accordance with examples as disclosed herein. In some examples, aspects of the operations of 1310 may be performed by an SRS port grouping manager 730 as described with reference to FIG. 7.

At 1315, the method may include performing the uplink transmission in conjunction with the SRS transmissions according to at least the second message. The operations of 1315 may be performed in accordance with examples as disclosed herein. In some examples, aspects of the operations of 1315 may be performed by an SRS transmission manager 735 as described with reference to FIG. 7.

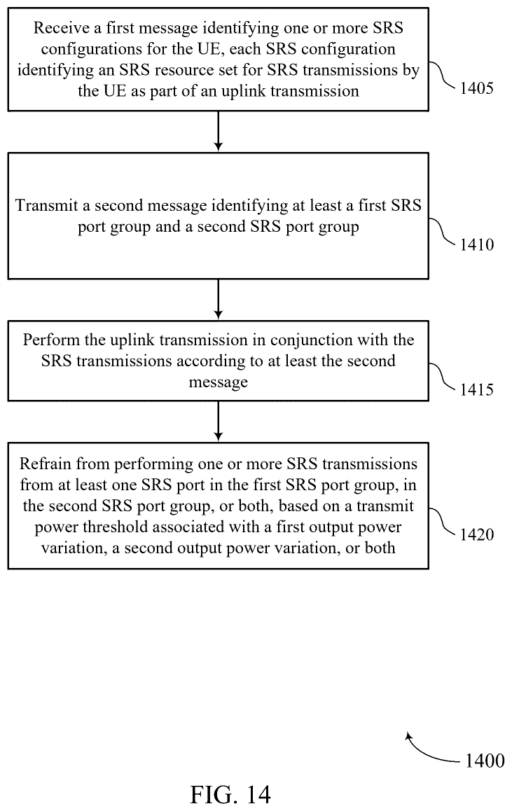

FIG. 14 shows a flowchart illustrating a method 1400 that supports exposure management in the spatial domain in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a first message identifying one or more SRS configurations for the UE, each SRS configuration identifying an SRS resource set for SRS transmissions by the UE as part of an uplink transmission. The operations of 1405 may be performed in accordance with examples as disclosed herein. In some examples, aspects of the operations of 1405 may be performed by an SRS configuration manager 725 as described with reference to FIG. 7.

At 1410, the method may include transmitting a second message identifying at least a first SRS port group and a second SRS port group. The operations of 1410 may be performed in accordance with examples as disclosed herein. In some examples, aspects of the operations of 1410 may be performed by an SRS port grouping manager 730 as described with reference to FIG. 7.

At 1415, the method may include performing the uplink transmission in conjunction with the SRS transmissions according to at least the second message. The operations of 1415 may be performed in accordance with examples as disclosed herein. In some examples, aspects of the operations of 1415 may be performed by an SRS transmission manager 735 as described with reference to FIG. 7.

At 1420, the method may include refraining from performing one or more SRS transmissions from at least one SRS port in the first SRS port group, in the second SRS port group, or both, based on a transmit power threshold associated with a first output power variation, a second output power variation, or both. The operations of 1420 may be performed in accordance with examples as disclosed herein. In some examples, aspects of the operations of 1420 may be performed by an SRS transmission manager 735 as described with reference to FIG. 7.

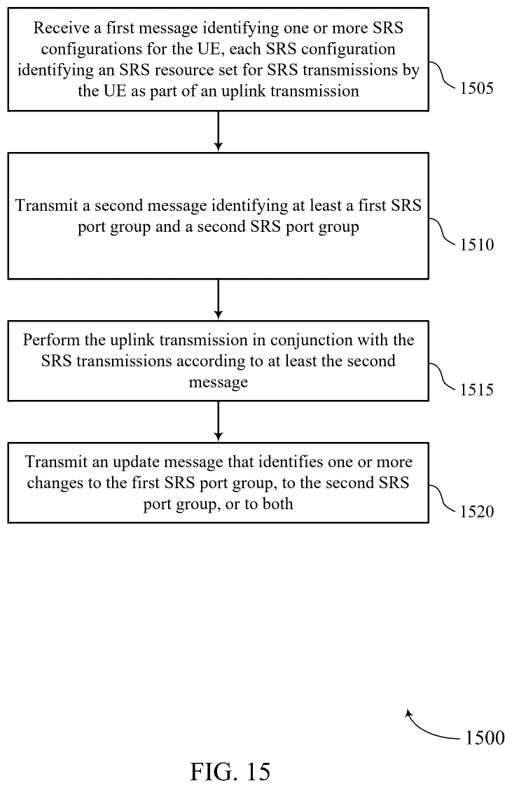

FIG. 15 shows a flowchart illustrating a method 1500 that supports exposure management in the spatial domain in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a first message identifying one or more SRS configurations for the UE, each SRS configuration identifying an SRS resource set for SRS transmissions by the UE as part of an uplink transmission. The operations of 1505 may be performed in accordance with examples as disclosed herein. In some examples, aspects of the operations of 1505 may be performed by an SRS configuration manager 725 as described with reference to FIG. 7.

At 1510, the method may include transmitting a second message identifying at least a first SRS port group and a second SRS port group. The operations of 1510 may be performed in accordance with examples as disclosed herein. In some examples, aspects of the operations of 1510 may be performed by an SRS port grouping manager 730 as described with reference to FIG. 7.

At 1515, the method may include performing the uplink transmission in conjunction with the SRS transmissions according to at least the second message. The operations of 1515 may be performed in accordance with examples as disclosed herein. In some examples, aspects of the operations of 1515 may be performed by an SRS transmission manager 735 as described with reference to FIG. 7.

At 1520, the method may include transmitting an update message that identifies one or more changes to the first SRS port group, to the second SRS port group, or to both. The operations of 1520 may be performed in accordance with examples as disclosed herein. In some examples, aspects of the operations of 1520 may be performed by an update manager 745 as described with reference to FIG. 7.

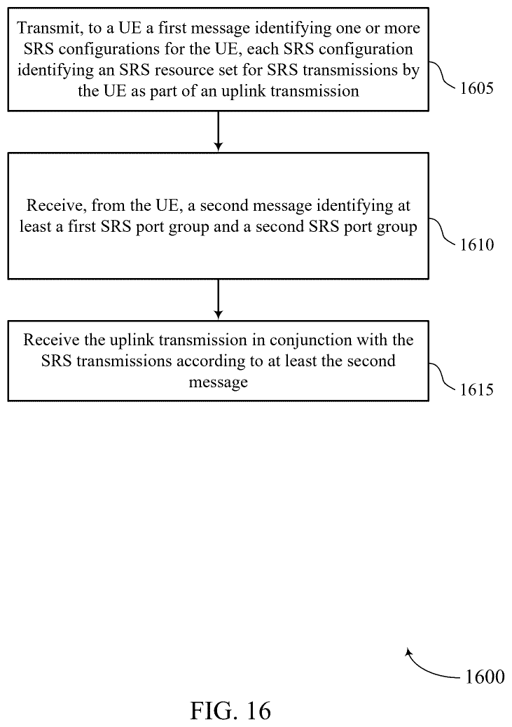

FIG. 16 shows a flowchart illustrating a method 1600 that supports exposure management in the spatial domain in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE a first message identifying one or more SRS configurations for the UE, each SRS configuration identifying an SRS resource set for SRS transmissions by the UE as part of an uplink transmission. The operations of 1605 may be performed in accordance with examples as disclosed herein. In some examples, aspects of the operations of 1605 may be performed by an SRS configuration manager 1125 as described with reference to FIG. 11.

At 1610, the method may include receiving, from the UE, a second message identifying at least a first SRS port group and a second SRS port group. The operations of 1610 may be performed in accordance with examples as disclosed herein. In some examples, aspects of the operations of 1610 may be performed by an SRS port grouping manager 1130 as described with reference to FIG. 11.

At 1615, the method may include receiving the uplink transmission in conjunction with the SRS transmissions according to at least the second message. The operations of 1615 may be performed in accordance with examples as disclosed herein. In some examples, aspects of the operations of 1615 may be performed by an SRS reception manager 1135 as described with reference to FIG. 11.

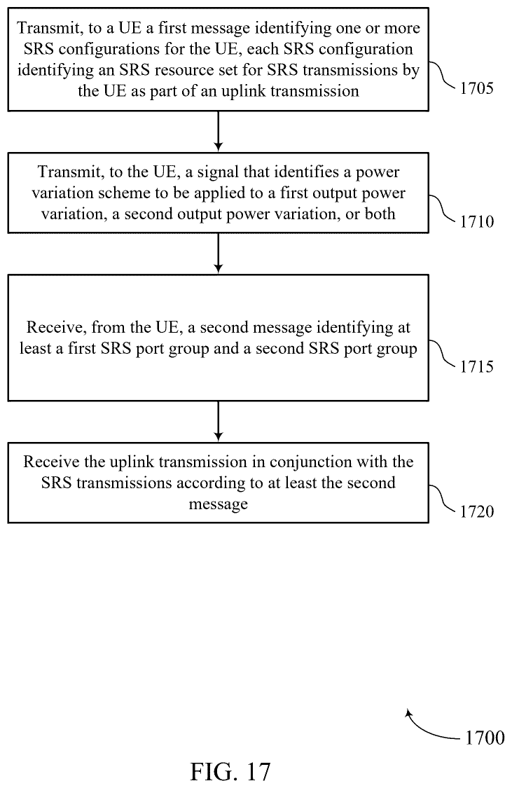

FIG. 17 shows a flowchart illustrating a method 1700 that supports exposure management in the spatial domain in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE a first message identifying one or more SRS configurations for the UE, each SRS configuration identifying an SRS resource set for SRS transmissions by the UE as part of an uplink transmission. The operations of 1705 may be performed in accordance with examples as disclosed herein. In some examples, aspects of the operations of 1705 may be performed by an SRS configuration manager 1125 as described with reference to FIG. 11.

At 1710, the method may include transmitting, to the UE, a signal that identifies a power variation scheme to be applied to a first output power variation, a second output power variation, or both. The operations of 1710 may be performed in accordance with examples as disclosed herein. In some examples, aspects of the operations of 1710 may be performed by a power variation manager 1140 as described with reference to FIG. 11.

At 1715, the method may include receiving, from the UE, a second message identifying at least a first SRS port group and a second SRS port group. The operations of 1715 may be performed in accordance with examples as disclosed herein. In some examples, aspects of the operations of 1715 may be performed by an SRS port grouping manager 1130 as described with reference to FIG. 11.

At 1720, the method may include receiving the uplink transmission in conjunction with the SRS transmissions according to at least the second message. The operations of 1720 may be performed in accordance with examples as disclosed herein. In some examples, aspects of the operations of 1720 may be performed by an SRS reception manager 1135 as described with reference to FIG. 11.

The following provides an overview of aspects of the present disclosure:

Aspect 1: A method for wireless communications at a UE, comprising: receiving a first message identifying one or more SRS configurations for the UE, each SRS configuration identifying an SRS resource set for SRS transmissions by the UE as part of an uplink transmission; transmitting a second message identifying at least a first SRS port group and a second SRS port group; and performing the uplink transmission in conjunction with the SRS transmissions according to at least the second message.

Aspect 2: The method of aspect 1, wherein individual SRS ports of the UE are selected for inclusion into the first SRS port group or the second SRS port group according to a threshold exposure limit of the UE.

Aspect 3: The method of any of aspects 1 through 2, wherein individual SRS ports are selected for inclusion into the first SRS port group or the second SRS port group on an SRS port basis or on an SRS resource basis within each SRS resource set.

Aspect 4: The method of any of aspects 1 through 3, wherein individual SRS ports are selected for inclusion into the first SRS port group or the second SRS port group on a per-band basis or on a per-band within a band combination basis.

Aspect 5: The method of any of aspects 1 through 4, wherein individual SRS ports are selected for inclusion into the first SRS port group or the second SRS port group on a per-carrier basis or on a per-carrier group basis.

Aspect 6: The method of any of aspects 1 through 5, wherein the second message further identifies a first output power variation for the first SRS port group and a second output power variation for the second SRS port group, and the first output power variation is different from the second output power variation.

Aspect 7: The method of any of aspects 1 through 6, wherein at least two SRS ports in the first SRS port group, in the second SRS port group, or both, are associated with different SRS resources.

Aspect 8: The method of any of aspects 1 through 7, wherein a transmit power difference associated with a first output power variation and a second output power variation is based at least in part on a maximum differential.

Aspect 9: The method of any of aspects 1 through 8, further comprising: refraining from performing one or more SRS transmissions from at least one SRS port in the first SRS port group, in the second SRS port group, or both, based at least in part on a transmit power threshold associated with a first output power variation, a second output power variation, or both.

Aspect 10: The method of any of aspects 1 through 9, further comprising: receiving a signal that identifies a power variation scheme to be applied to a first output power variation, a second output power variation, or both.

Aspect 11: The method of any of aspects 1 through 10, further comprising: transmitting an update message that identifies one or more changes to the first SRS port group, to the second SRS port group, or to both.

Aspect 12: The method of aspect 11, wherein a timing associated with transmission of the update message is based at least in part on a timer associated with SRS port group changes.

Aspect 13: The method of any of aspects 11 through 12, wherein transmission of the update message is based at least in part on occurrence of a triggering event associated with the UE.

Aspect 14: A method for wireless communications at a network entity, comprising: transmitting, to a UE a first message identifying one or more SRS configurations for the UE, each SRS configuration identifying an SRS resource set for SRS transmissions by the UE as part of an uplink transmission; receiving, from the UE, a second message identifying at least a first SRS port group and a second SRS port group; and receiving the uplink transmission in conjunction with the SRS transmissions according to at least the second message.

Aspect 15: The method of aspect 14, wherein individual SRS ports of the UE are selected for inclusion into the first SRS port group or the second SRS port group according to a threshold exposure limit of the UE.

Aspect 16: The method of any of aspects 14 through 15, wherein individual SRS ports are selected for inclusion into the first SRS port group or the second SRS port group on an SRS port basis or on an SRS resource basis within each SRS resource set.

Aspect 17: The method of any of aspects 14 through 16, wherein individual SRS ports are selected for inclusion into the first SRS port group or the second SRS port group on a per-band basis or on a per-band within a band combination basis.

Aspect 18: The method of any of aspects 14 through 17, wherein individual SRS ports are selected for inclusion into the first SRS port group or the second SRS port group on a per-carrier basis or on a per-carrier group basis.

Aspect 19: The method of any of aspects 14 through 18, wherein the second message further identifies a first output power variation for the first SRS port group and a second output power variation for the second SRS port group, and the first output power variation is different from the second output power variation.

Aspect 20: The method of any of aspects 14 through 19, wherein at least two SRS ports in the first SRS port group, in the second SRS port group, or both, are associated with different SRS resources.

Aspect 21: The method of any of aspects 14 through 20, wherein a transmit power difference associated with a first output power variation and a second output power variation is based at least in part on a maximum differential.

Aspect 22: The method of any of aspects 14 through 21, further comprising: refraining from receiving one or more SRS transmissions from at least one SRS port in the first SRS port group, in the second SRS port group, or both, based at least in part on a transmit power threshold associated with a first output power variation, a second output power variation, or both.

Aspect 23: The method of any of aspects 14 through 22, further comprising: transmitting, to the UE, a signal that identifies a power variation scheme to be applied to a first output power variation, a second output power variation, or both.

Aspect 24: The method of any of aspects 14 through 23, further comprising: receiving, from the UE, an update message that identifies one or more changes to the first SRS port group, to the second SRS port group, or to both.

Aspect 25: The method of aspect 24, wherein a timing associated with reception of the update message is based at least in part on a timer associated with SRS port group changes.

Aspect 26: The method of any of aspects 24 through 25, wherein reception of the update message is based at least in part on occurrence of a triggering event associated with the UE.

Aspect 27: A UE for wireless communications, comprising one or more memories storing processor-executable code, and one or more processors coupled with the one or more memories and individually or collectively operable to execute the code to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first message identifying one or more sounding reference signal (SRS) configurations for the UE, each SRS configuration identifying an SRS resource set for SRS transmissions by the UE as part of an uplink transmission;
transmit a second message identifying at least a first SRS port group and a second SRS port group; and
perform the uplink transmission in conjunction with the SRS transmissions according to at least the second message.

2. The UE of claim 1, wherein individual SRS ports of the UE are selected for inclusion into the first SRS port group or the second SRS port group according to a threshold exposure limit of the UE.

3. The UE of claim 1, wherein individual SRS ports are selected for inclusion into the first SRS port group or the second SRS port group on an SRS port basis or on an SRS resource basis within each SRS resource set.

4. The UE of claim 1, wherein individual SRS ports are selected for inclusion into the first SRS port group or the second SRS port group on a per-band basis or on a per-band within a band combination basis.

5. The UE of claim 1, wherein individual SRS ports are selected for inclusion into the first SRS port group or the second SRS port group on a per-carrier basis or on a per-carrier group basis.

6. The UE of claim 1, wherein:
the second message further identifies a first output power variation for the first SRS port group and a second output power variation for the second SRS port group, and
the first output power variation is different from the second output power variation.

7. The UE of claim 1, wherein:
at least two SRS ports in the first SRS port group, in the second SRS port group, or both, are associated with different SRS resources.

8. The UE of claim 1, wherein a transmit power difference associated with a first output power variation and a second output power variation is based at least in part on a maximum differential.

9. The UE of claim 1, wherein the one or more processors are individually or collectively further operable to execute the code to cause the UE to:
refrain from performing one or more SRS transmissions from at least one SRS port in the first SRS port group, in the second SRS port group, or both, based at least in part on a transmit power threshold associated with a first output power variation, a second output power variation, or both.

10. The UE of claim 1, wherein the one or more processors are individually or collectively further operable to execute the code to cause the UE to:
receive a signal that identifies a power variation scheme to be applied to a first output power variation, a second output power variation, or both.

11. The UE of claim 1, wherein the one or more processors are individually or collectively further operable to execute the code to cause the UE to:
transmit an update message that identifies one or more changes to the first SRS port group, to the second SRS port group, or to both.

12. The UE of claim 11, wherein a timing associated with transmission of the update message is based at least in part on a timer associated with SRS port group changes.

13. The UE of claim 11, wherein transmission of the update message is based at least in part on occurrence of a triggering event associated with the UE.

14. A network entity, comprising:
one or more memories storing processor-executable code; and
one or more processors coupled with the one or more memories and individually or collectively operable to execute the code to cause the network entity to:
transmit, to a user equipment (UE) a first message identifying one or more sounding reference signal (SRS) configurations for the UE, each SRS configuration identifying an SRS resource set for SRS transmissions by the UE as part of an uplink transmission;
receive, from the UE, a second message identifying at least a first SRS port group and a second SRS port group; and
receive the uplink transmission in conjunction with the SRS transmissions according to at least the second message.

15. The network entity of claim 14, wherein individual SRS ports of the UE are selected for inclusion into the first SRS port group or the second SRS port group according to a threshold exposure limit of the UE.

16. The network entity of claim 14, wherein individual SRS ports are selected for inclusion into the first SRS port group or the second SRS port group on an SRS port basis or on an SRS resource basis within each SRS resource set.

17. The network entity of claim 14, wherein individual SRS ports are selected for inclusion into the first SRS port group or the second SRS port group on a per-band basis or on a per-band within a band combination basis.

18. The network entity of claim 14, wherein individual SRS ports are selected for inclusion into the first SRS port group or the second SRS port group on a per-carrier basis or on a per-carrier group basis.

19. The network entity of claim 14, wherein:
the second message further identifies a first output power variation for the first SRS port group and a second output power variation for the second SRS port group, and
the first output power variation is different from the second output power variation.

20. A method for wireless communications at a user equipment (UE), comprising:
receiving a first message identifying one or more sounding reference signal (SRS) configurations for the UE, each SRS configuration identifying an SRS resource set for SRS transmissions by the UE as part of an uplink transmission;
transmitting a second message identifying at least a first SRS port group and a second SRS port group; and
performing the uplink transmission in conjunction with the SRS transmissions according to at least the second message.
